(19) United States
(12) Patent Application Publication
(10) Pub. No.: US 2025/0336120 A1
(43) Pub. Date: Oct. 30, 2025

(54) METHOD, APPARATUS, DEVICE, AND STORAGE MEDIUM FOR COMPONENT DRAWING

(71) Applicant: Beijing Zitiao Network Technology Co., Ltd., Haidian District (CN)

(72) Inventors: Long Chen, Beijing (CN); Kunlun Wang, Beijing (CN)

(21) Appl. No.: 19/189,788

(22) Filed: Apr. 25, 2025

Related U.S. Application Data
(63) Continuation of application No. PCT/CN2024/089908, filed on Apr. 25, 2024.

(51) Int. Cl. G06T 11/40; G06T 11/20

(52) U.S. Cl. CPC G06T 11/40; G06T 11/20

(57) ABSTRACT

A method for component drawing includes: filling a first background of a first component by using a target element; determining first drawing information of the first component, the first drawing information including at least one of a first start position of the target element or a first end position of the target element in the first component, wherein the first start position and the first end position indicating an offset position of the target element; determining, based on the first drawing information, second drawing information of a second component associated with the first component, the second drawing information including at least one of a second start position of the target element or a second end position of the target element in the second component; and filling a second background of the second component by using the target element based on the second drawing information.

### CROSS REFERENCE

The application claims priority to PCT Patent Application No. PCT/CN2024/089908, filed on Apr. 25, 2024, and entitled “METHOD, APPARATUS, DEVICE, AND STORAGE MEDIUM FOR COMPONENT DRAWING”, the entirety of which is incorporated herein by reference.

### FIELD

Example embodiments of the present disclosure generally relate to the field of computers, and more particularly, to a method, apparatus, device, and computer-readable storage medium for component drawing.

### BACKGROUND

When a plurality of adjacent components uses an entire background image, a background image is generally provided on a parent container shared by a plurality of components, and backgrounds of internal sub-components are transparent, so that an effect that a plurality of adjacent components share one background image can be achieved visually.

### SUMMARY

In a first aspect of the present disclosure, a method of component drawing is provided, the method including: filling a first background of a first component by using a target element; determining first drawing information of the first component, the first drawing information including at least one of a first start position of the target element or a first end position of the target element in the first component, wherein the first start position and the first end position indicating an offset position of the target element; determining, based on the first drawing information, second drawing information of a second component associated with the first component, the second drawing information including at least one of a second start position of the target element or a second end position of the target element in the second component; and filling a second background of the second component by using the target element based on the second drawing information.

In a second aspect of the present disclosure, a method of component display is provided, the method including: filling a first background of a first component and a second background of a second component by using a target element, where the first component is adjacent to the second component, and the first component and the second component have different sizes; displaying the first component and the second component such that the target element is continuously presented across the first background of the first component and the second background of the second component; and in response to a move operation for at least one of the first component or the second component, moving the first component and the second component such that the first background and the second background move in coordination with the first component and the second component.

In a third aspect of the present disclosure, an apparatus for component display is provided, the apparatus including: a first filling module configured to fill a first background of a first component by using a target element; a first determining module configured to determine first drawing information of the first component, the first drawing information including at least one of a first start position of the target element or a first end position of the target element in the first component, wherein the first start position and the first end position indicate an offset position of the target element; a second determining module configured to determine, based on the first drawing information, second drawing information of a second component associated with the first component, the second drawing information including at least one of a second start position of the target element or a second end position of the target element in the second component; and a second filling module configured to fill a second background of the second component by using the target element based on the second drawing information.

In a fourth aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect or the second aspect.

In a fifth aspect of the present disclosure, a computer readable storage medium is provided, where the computer readable storage medium stores a computer program thereon, and the computer program is executable by a processor to implement the method in the first aspect or the second aspect.

It should be appreciated that what is described in this section is not intended to limit critical features or essential features of embodiments of the present disclosure, nor is it intended to limit the scope of the present disclosure. Other features of the present disclosure will be readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference signs denote the same or similar elements, where:

FIG. 1 illustrates a schematic diagram of an example environment in which embodiments according to the present disclosure may be implemented;

FIG. 2 illustrates a flowchart of an example process for component drawing according to some embodiments of the disclosure;

FIGS. 3A-B illustrate example interfaces according to some embodiments of the present disclosure;

FIG. 4 illustrates a schematic block diagram of an example apparatus for component drawing according to some embodiments of the disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, but rather, these embodiments are provided for a thorough and complete understanding of this present disclosure. It should be understood that the drawings and embodiments of the present disclosure are for illustrative purposes only and are not intended to limit the scope of the present disclosure.

It is important to note that heading of any section/subsection provided in this article is not limiting. Various embodiments are described throughout herein, and any type of embodiments can be included under any section/subsection. Furthermore, the embodiments described in any section/subsection may be combined in any way with any other embodiments described in the same section/subsection and/or in a different section/subsection.

In the description of embodiments of the present disclosure, the term “including” and similar expressions shall be understood as an open-ended inclusion, that is, “including but not limited to”. The term “based on” should be understood to mean “based at least in part on.” The term “an embodiment” or “the embodiment” shall be understood to mean “at least one embodiment”. The term “some embodiments” should be understood as “at least some embodiments”. Other explicit and implicit definitions may be included below. The terms “first”, “second”, etc. may refer to different or the same object. Other explicit and implicit definitions may be included below.

The embodiments of the present disclosure may involve user data, the obtaining and/or use of data, etc. These aspects comply with corresponding laws, regulations and relevant regulations. In the embodiments of this disclosure, collection, obtaining, processing, processing, forwarding, use, etc. of all data are performed with the user's knowledge and confirmation. Accordingly, when implementing each embodiment of the present disclosure, users should be informed of the type, scope of use, usage scenarios, etc. that may be involved in the data or information and obtain their authorization through appropriate means in accordance with relevant laws and regulations. The specific notification and/or authorization methods may vary according to the actual situation and application scenarios, and the scope of the present disclosure is not limited in this regard.

The technical solution in this specification and embodiments, if the processing of personal information is involved, the processing will be carried out on the premise that there is a basis of legality (e.g., consent of the subject of the personal information is obtained or it is necessary to fulfill a contract, etc.), and the processing will be carried out only within the scope of the stipulations or agreements. The user refusing to process personal information other than that which is necessary for the basic functions will not affect the user's use of the basic functions.

In some traditional solutions, for example, when a plurality of adjacent components use an entire background image, the background image is generally provided on a parent container shared by a plurality of components, and backgrounds of internal sub-components are transparent, so that an effect that a plurality of adjacent components share one background image can be achieved visually. However, this solution cannot be applied to sub-components of a sliding list.

Based on requirements for abundant information in reality, presenting these pieces of information content in a component of the sliding list will form a content list capable of being continuously slid up and down, each piece of information content may occupy a sub-component, and these pieces of information content can be slid in and out of a visible range. When it is required that a plurality of adjacent sub-components in the sliding list share a background, the background may follow the sliding of the sub-components, because these sub-components only occupy a part of the parent container, the positions thereof are slidable, and the sub-components may also be slid in and out, and the width and height thereof are also dynamically changeable. In this case, the scheme of providing a background map in a parent container cannot be used.

Embodiments of the disclosure propose a solution for component drawing. According to this solution, a first background of a first component may be filled by using a target element; first drawing information of a first component is determined, the first drawing information including at least one of a first start position of the target element or a first end position of the target element in the first component, wherein the first start position and the first end position indicating an offset position of the target element; second drawing information of a second component associated with the first component is determined based on the first drawing information, the second drawing information including at least one of a second start position of the target element or a second end position of the target element in the second component; and a second background of the second component is filled by using the target element based on the second drawing information.

In this way, in the embodiments of the present disclosure, in a sliding scenario or a fixed arrangement scenario, an effect that a plurality of dynamically changed adjacent components share a background image can be achieved. Thus, the embodiments of the present disclosure can improve the consistency between display of components, and can support adjustment for dynamic content, thereby improving reliability of carrying content by the components.

Various example implementations of the solution are described in further detail below with reference to the accompanying drawings.

### Example Environment

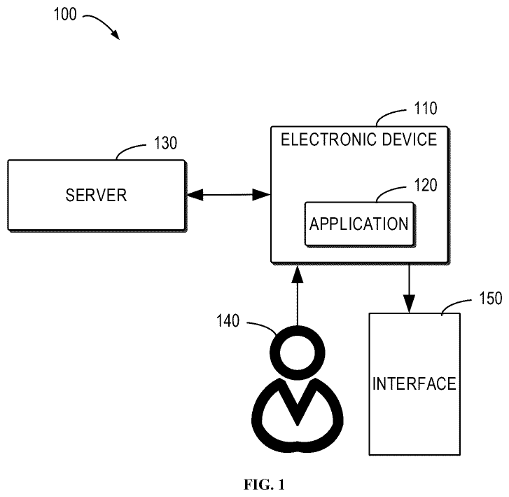

FIG. 1 illustrates a schematic diagram of an example environment 100 in which embodiments of the present disclosure can be implemented. As shown in FIG. 1, example environment 100 may include an electronic device 110.

In this example environment 100, an application 120 that supports interface interaction may run on an electronic device 110. The application 120 may be any suitable type of application for interface interaction, examples of which may include but are not limited to: a video application, a social application, or other appropriate applications. A user 140 may interact with application 120 via the electronic device 110 or its attached devices.

In the environment 100 of FIG. 1, if the application 120 is in an active state, the electronic device 110 may display an interface 150 for supporting interface interaction through the application 120.

In some embodiments, the electronic device 110 communicates with the server 130 to enable provision of services to the application 120. The electronic device 110 may be any type of a mobile terminal, a fixed terminal or a portable terminal, including a mobile phone, a desktop computer, a laptop computer, a notebook computer, a netbook computer, a tablet computer, a media computer, a multimedia tablet, a palmtop computer, a portable game terminal, a VR/AR equipment, a Personal Communication System (PCS) device, a personal navigation device, a Personal Digital Assistant (PDA), an audio/video player, a digital cameras/camcorder, a positioning device, a TV receiver, a radio receiver, an e-book device, a gaming device, or any combination of the foregoing, including accessories and peripherals for these devices or any combination thereof. In some embodiments, the electronic device 110 can also support any type of interface targeted to the user (such as “wearable” circuitry, etc.).

The server 130 may be an independent physical server, or a server cluster or distributed system consisted of a plurality of physical servers, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the applications 120 in the electronic device 110 that support virtual scenarios.

A communication connection may be established between the server 130 and the electronic device 110. Communication connections can be established via wired or wireless manner. Communication connections may include but are not limited to Bluetooth connections, mobile network connections, Universal Serial Bus (USB) connections, Wireless Fidelity (WIFI) connections, etc. The embodiments of the present disclosure are not limited in this regard. In the embodiments of the present disclosure, the server 130 and the electronic device 110 can implement signaling interaction through the communication connection therebetween.

It should be understood that the structure and function of various elements in environment 100 are described for illustrative purposes only and do not imply any limitation on the scope of the present disclosure.

Some example embodiments of the present disclosure will continue to be described below with reference to the accompanying drawings.

### Example Process

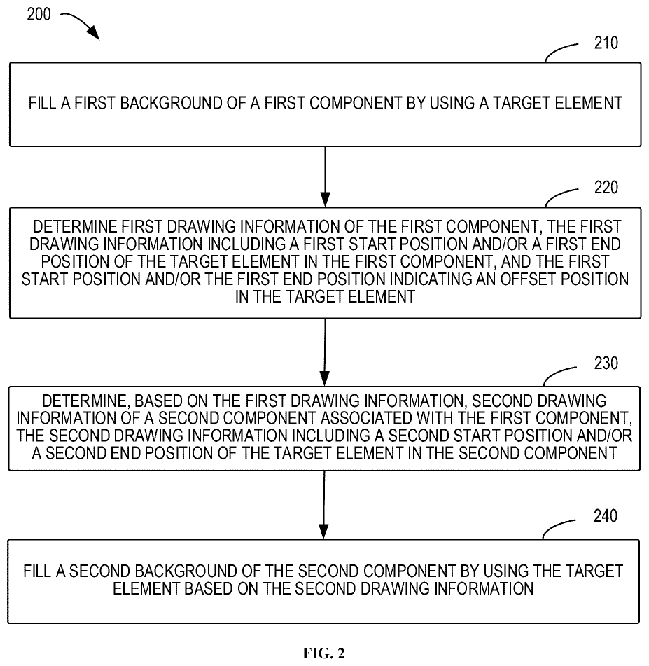

FIG. 2 illustrates a flowchart of an example process for component drawing 200 according to some embodiments of the disclosure. The process 200 can be implemented at electronic device 110. The process 200 is described below with reference to FIG. 1.

At block 210, the electronic device 110 fills a first background of a first component by using a target element.

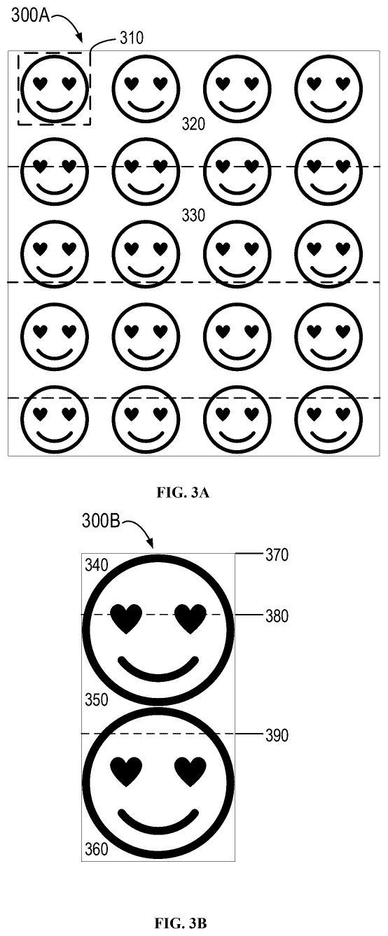

In some embodiments, referring to FIG. 3A, the electronic device 110 may fill a first background of a first component 320 by using a target element 310. It can be understood that, if the target element is not enough to fill the first component, the electronic device 110 splices the target element to obtain the first background of the first component. That is, the first background may be filled by a portion of a target element, a single target element, or more target elements.

In some embodiments, such target elements may include, but are not limited to, various types of graphical elements, e. g., images, expressions, stickers, etc.

In some embodiments, the size of such a first component may be dynamically changed. As an example, the size of the first component may vary depending on the information content to be displayed within the first component. For example, the first component may be a component for displaying a comment, and then the size of the first component may correspondingly change according to the length of the content of the comment.

At block 220, the electronic device 110 determines first drawing information of the first component, the first drawing information including at least one of a first start position of the target element or a first end position of the target element in the first component, the first start position and the first end position indicating an offset position of the target element.

In some embodiments, referring to FIG. 3B, the drawing includes three components 340, 350, and 360. For ease of understanding, the following is described by taking the component 340 as a first component.

In some embodiments, the electronic device 110 may determine the first drawing information of the first component based on the size information of the first component. The size information varies based on content presented in the first component. Referring to FIG. 3B, the first drawing information includes at least one of a first start position 370 or a first end position 380 of the target element in the component 340.

As shown in FIG. 3B, the first start position 370 and the first end position 380 may represent an offset position in a target element. For example, the first start position 370 may correspond to a height “0” of the target element; the first end position may correspond to a height offset of a corresponding position in the target element, e. g., “h1”. It should be appreciated that after determining the first start position 370, the electronic device 110 may determine the corresponding first end position 380 based on the height of the component 340.

In some embodiments, if the first component is at the first position (for example, a position of an initial component in a parent container shared by a plurality of sub-components) and is drawn at first, the electronic device 110 may draw a target element from the first initial position of the first component, and the first end position is the height of the first component, that is, the height of the first component is the height of the target element occupied by the first component. It may be understood that the target elements to be occupied may be one or more. In this manner, the electronic device 110 may obtain the first drawing information of the first component.

In some embodiments, the list of components formed from a plurality of adjacent components includes a first component and a second component. The electronic device 110 may determine whether the first component is a first one of components in the component list based on the following process. In particular, the electronic device 110 may determine whether the component list includes a third component associated with the first component, where the third component has a higher priority in the component list than the first component. As an example, as shown in FIG. 3B, the electronic device 110 may determine that the component list includes a component 340 with a higher priority than the component 350, but not including another component with a higher priority than the component 340. Accordingly, the electronic device 110 may determine that the component 340 is the first one of components in the component list and may determine the first start position 370 of the component 370 based on a predetermined offset (e. g., 0) of the filling element.

Further, the electronic device 110 determines the first end position 380 based on the size information (e. g., height or width) of the component 370 and the first start position 370.

In some other embodiments, if the component list includes a third component with a higher priority than the component currently to be calculated, the electronic device 110 may accordingly determine a start position or an end position of the current component based on the drawing information of the third component. For example, as introduced below, the start position of the component 350 may correspond to the end position of the component 370.

At block 230, the electronic device 110 determines second drawing information of a second component associated with the first component based on the first drawing information, the second drawing information including at least one of a second start position of the target element or a second end position of the target element in the second component.

In some embodiments, the electronic device 110 constructs a first node corresponding to the first component and a second node corresponding to the second component and establishes an association between the first node and the second node to indicate an association between the first component and the second component. The electronic device 110 stores the first drawing information of the first component in the first node. As an example, information of the first start location and the first end position of the first component are stored in the first node.

In some embodiments, in response to completing storage of the first drawing information in the first node, the electronic device 110 determines the second drawing information based on the first drawing information to store the second drawing information in the second node. As an example, after determining the second drawing information, the electronic device stores information of the second start location and the second end position of the second component in the second node.

As an example, the electronic device 110 can construct such a node through a Doubly Linked List. As an example, a data structure of such a node may include a plurality of fields: a “prev” field for representing a previous node in the Doubly Linked List; a “next” field for representing a next node in the Doubly Linked List; a “startoffset” field for representing a start drawing position corresponding to the node; an “endoffset” field for indicating the end drawing position corresponding to the node; and the “iscompletelayout” for indicating whether the current node has completed position calculation.

In this manner, the embodiments of the present disclosure may manage a plurality of components in a component list in a manner of a Doubly Linked List, and may characterize location adjacency between components by association between nodes in the linked list.

In some embodiments, the electronic device 110 determines a target direction of the second component relative to the first component. Referring to FIG. 3B, the target direction of the second component 350 relative to the first component 340 is downward. The electronic device 110 determines the second drawing information of the second component according to the target direction and based on the first drawing information. Such second drawing information may be, for example, that the second start position of the target element in the second component is 380 and the second end position is 390.

In some embodiments, in response to the target direction being a first direction, the electronic device 110 determines the second end position based on the first start position. Referring to FIG. 3B, such a first direction may be upward. When the component is slid downward, the first start position of the first component is 380, the first end position of the first component is 370, the second start position of the second component is 390, and the end position of the second component is 380.

In some embodiments, in response to the target direction being a second direction, the electronic device 110 determines the first start position based on the first end position. As an example, such a second direction may be downward. When the component is slid upward, the first start position of the first component is 370, the first end position of the first component is 380, the second start location of the second component is 380, and the end position of the second component is 390.

In some embodiments, if the first component is at the first position and is drawn at last, the electronic device 110 needs to obtain position information about the target element occupied by the next component of the first component, and the first component needs to occupy the target element forward and calculate the occupation position information.

In some embodiments, if the first component is at the last position and the first component is drawn firstly, the electronic device 110 may place the first component at an end position of the target element, and may also perform adjustment according to a requirement. For example, the electronic device 110 may record a position of the first component, and when the first component is drawn firstly, the position information when calculating previously by taking the first component as the last drawn component will be directly used. In this manner, the position of the target element occupied by the plurality of components sharing the target element does not change when sliding in reverse.

In some embodiments, if the first component is at the last position and the first component is drawn at last, the electronic device 110 needs to obtain the end position of the target element occupied by the previous component thereof, as the start position of the target element occupied by the first component, and then the end position of the target element occupied by the first component is calculated in combination with the height of the first component.

In some embodiments, if the first component is an intermediate component (there are components sharing the target element in the front and thereafter) and the sliding direction is from front to back, the electronic device 110 needs to obtain the position information of the target element occupied by the previous component, then the first component occupies the target element backward, and calculates the occupation position information.

In some embodiments, if the first component is an intermediate component (there are components sharing the target element in the front and thereafter) and the sliding direction is from back to front, the electronic device 110 needs to obtain position information of a target element occupied by the subsequent component, then the first component occupies the target element forward, and calculates the occupation position information.

In some embodiments, the target element may be smaller in height than the subcomponent content, or larger in height than the subcomponent content. Both the size of the target element and the size of each sub-component can be adjusted at will, and the two components are not necessarily matched in coordination.

In some embodiments, if there are a large number of subcomponents and the target element cannot satisfy a plurality of subcomponents, the electronic device 110 may repeatedly splice the target element to adapt to the size of the subcomponents. If the height of the target element is smaller than that of the subcomponent, the target element is automatically spliced again to fill the backgrounds of the subcomponents, so as to ensure that an entire splicing unit can be spliced at a connection position between adjacent sub-components, so that the background of all the sub-components sharing the target element appear as a whole.

In some embodiments, the electronic device 110 may obtain the second drawing information of the second component based on the processes described above.

At block 240, the electronic device 110 fills a second background of the second component by using the target element based on the second drawing information.

In some embodiments, the electronic device 110 fills the second background of the second component by using the target element based on information of the second start position and the second end position. Thus, as shown in FIG. 3B, the electronic device 110 may cause the component 340 and the component 350 to have a continuous background filling effect. In addition, in a case where the height of the component 340 varies due to the content, the electronic device 110 may recalculate the drawing information of the component 350 based on the drawing information of the component 340, and the background continuity thereof may still be ensured. Compared with the conventional setting background for each component independently, the embodiments of the present disclosure can reduce labor cost of background adjustment, and can improve the reliability of the components in displaying dynamic content.

In this way, in the embodiments of the present disclosure, in a sliding scenario or a fixed arrangement scenario, an effect that a plurality of dynamically changed adjacent components shares a background image can be achieved. Thus, the embodiments of the present disclosure can improve consistency between display of components, and can support the adjustment of dynamic content, thereby improving the reliability of component in carrying content.

In some embodiments, an embodiment of the present disclosure further provides a method for displaying a component. Specifically, as discussed above, the electronic device 110 may fill a first background of a first component and a second background of a second component by using a target element, where the first component is adjacent to the second component, and the first component and the second component have different sizes.

Using FIG. 3B as an example, the electronic device 110 may fill components 340, 350, and 360 by using the target element. The components 340 and 350 may, for example, have different sizes.

Further, the electronic device 110 may display the first component and second component such that the target element is continuously presented across the first background of the first component and the second background of the second component. As shown in FIGS. 3A and 3B, based on the filling process described above, the embodiments of the present disclosure may ensure that the target element is continuously presented across different components. For example, the components 340 and 350 may continuously represent different portions of a single target element.

Further, in response to a move operation for at least one of the first or second components, the electronic device 110 may move the first component and the second component such that the first background and the second background move in coordination with the first component and the second component.

Continuing with FIG. 3B as an example, when the electronic device 110 receives a move operation (e. g., a sliding up operation) for the component 340, the component 350, or the component 360, the electronic device 110 may move the component 340, the component 350, and the component 360 accordingly.

In addition, the electronic device 110 may also control the backgrounds in the component 340, the component 350, and the component 360 to move in coordination with the corresponding component. That is, during the sliding process, the component 340 may retain a corresponding portion of the target element as shown in FIG. 3B. Thus, the embodiments of the present disclosure may continue to maintain continuity of a target element across different components during movement of a plurality of adjacent components.

Based on such a manner, the embodiments of the present disclosure can support continuous filling of background of a plurality of associated components, and ensure the continuity of the background during the movement of the components, so that the components can be used more effectively to present corresponding information, thereby improving the efficiency of acquiring information in the components.

### Example Apparatus and Device

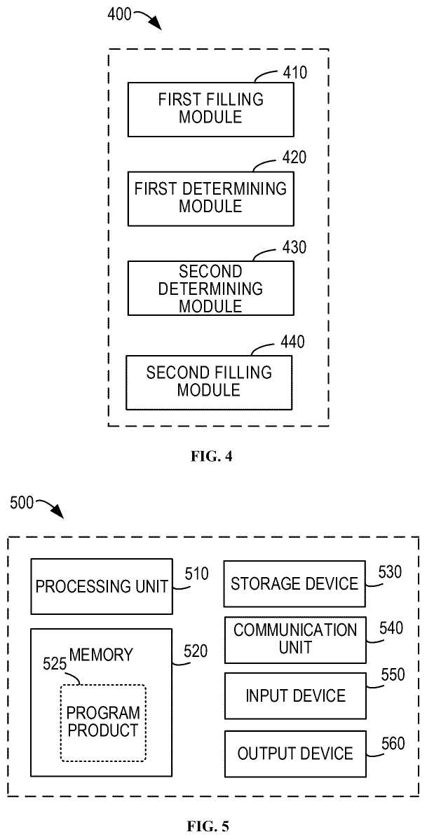

Embodiments of the present disclosure also provide a corresponding apparatus for implementing the methods or processes described above. FIG. 4 illustrates a schematic structural block diagram for an example apparatus for component drawing 400 in accordance with certain embodiments of the present disclosure. The apparatus 400 may be implemented as or included in an electronic device 110. The various modules/components in the apparatus 400 may be implemented by hardware, software, firmware, or any combination thereof.

As shown in FIG. 4, the apparatus 400 includes a first filling module 410 configured to fill a first background of a first component by using a target element; a first determining module 420 configured to configured to determine first drawing information of the first component, the first drawing information including at least one of a first start position of the target element or a first end position of the target element in the first component, wherein the first start position and the first end position indicate an offset position of the target element; a second determining module 430 configured to determine, based on the first drawing information, second drawing information of a second component associated with the first component, the second drawing information including at least one of a second start position of the target element or a second end position of the target element in the second component; and a second filling module 440 configured to fill a second background of the second component by using the target element based on the second drawing information.

In some embodiments, the second determining module 430 is specifically configured to determine a target direction of the second component relative to the first component; and determine the second drawing information of the second component according to the target direction and based on the first drawing information.

In some embodiments, the second determining module 430 is specifically configured to determine, in response to the target direction being a first direction, the second end position based on the first start position; or determine, in response to the target direction being a second direction, the second start position based on the first end position.

In some embodiments, the first determining module 420 is specifically configured to determine the first drawing information of the first component based on size information of the first component.

In some embodiments, the sizing information varies based on the content presented in the first component.

In some embodiments, the first component and the second component are included in a component list, and the first determining module 420 is specifically configured to determine whether the component list includes a third component associated with the first component, the third component having a higher priority in the component list than the first component; in response to the component list not including the third component, determine the first start position of the first component based on a predetermined offset of the filling element; and determine the first end position based on size information of the first component and the first start position.

In some embodiments, the first determining module 420 is specifically configured to determine, in response to the component list including the third component, determine a first start position of the first component based on third drawing information of the third component; and determine the first end position of the first component based on the first start location.

In some embodiments, the apparatus 400 further includes a processing module configured to construct a first node corresponding to the first component and a second node corresponding to the second component; establish an association between a first node and a second node to indicate an association between the first component and the second component; and storing the first drawing information of the first component in the first node.

In some embodiments, the second determining module 430 is specifically configured to determine, in response to completing storage of the first drawing information in the first node, determine the second drawing information based on the first drawing information to store the second drawing information in the second node.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, exemplary types of hardware logic components that may be used include field programmable gate arrays (FPGAs), application specific integrated circuits (ASICs), application specific standard products (ASSPs), system-on-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device shown in FIG. 5 may be used to implement the electronic device 110 of FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve the parallel processing capability of electronic device 500.

The electronic device 500 typically includes a plurality of computer storage media. Such media may be any available media accessible by the electronic device 500, including, but not limited to, volatile and non-volatile media, removable and non-removable media. The memory 520 may be a volatile memory (e.g., a register, a cache, a random-access memory (RAM)), a non-volatile memory (e.g., read-only memory (ROM), an electrically erasable programmable read-only memory (EEPROM), flash memory), or some combination thereof. A storage device 530 may be a removable or non-removable medium and may include a machine-readable medium, such as a flash drive, a magnetic disk, or any other medium, which may be used to store information and/or data and may be accessed within the electronic device 500.

The electronic device 500 may further include additional removable/non-removable, volatile/non-volatile storage media. Although not shown in FIG. 5, a disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communications unit 540 implements communications with other electronic devices over a communications medium. Additionally, the functionality of components of the electronic device 500 may be implemented in a single computing cluster or a plurality of computing machines capable of communicating over a communication connection. Thus, the electronic device 500 may operate in a networked environment using logical connections to one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) such as a storage device, a display device, or the like through the communication unit 540 as required, and communicate with one or more devices that enable a user to interact with the electronic device 500, or communicate with any device (e. g., a network card, a modem, or the like) that enables the electronic device 500 to communicate with one or more other electronic devices. Such communication may be performed via an input/output (I/O) interface (not shown).

According to exemplary implementations of the present disclosure, there is provided a computer-readable storage medium having computer instructions stored thereon, where the computer instructions are executed by a processor to implement the method described above. In accordance with exemplary implementations of the present disclosure, there is also provided a computer program product, and the computer program product is tangibly stored on a non-transient computer-readable medium and includes computer-executable instructions, and the computer-executable instructions are executed by the processor to implement the above-described method.

Aspects of the present disclosure are described herein with reference to flowcharts and/or block diagrams of methods, apparatuses, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may also be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some replaced implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method of component drawing, comprising:
filling a first background of a first component by using a target element;
determining first drawing information of the first component, the first drawing information comprising at least one of a first start position of the target element or a first end position of the target element in the first component, wherein the first start position and the first end position indicating an offset position of the target element;
determining, based on the first drawing information, second drawing information of a second component associated with the first component, the second drawing information comprising at least one of a second start position of the target element or a second end position of the target element in the second component; and
filling a second background of the second component by using the target element based on the second drawing information.

2. The method of claim 1, wherein determining, based on the first drawing information, the second drawing information of the second component associated with the first component comprises:
determining a target direction of the second component relative to the first component; and
determining the second drawing information of the second component according to the target direction and based on the first drawing information.

3. The method of claim 2, wherein determining the second drawing information of the second component according to the target direction of the second component relative to the first component and based on the first drawing information comprises:
in response to the target direction being a first direction, determining the second end position based on the first start position, or
in response to the target direction being a second direction, determining the second start position based on the first end position.

4. The method of claim 1, wherein determining the first drawing information of the first component comprises:
determining the first drawing information of the first component based on size information of the first component.

5. The method of claim 4, wherein the size information varies based on content presented in the first component.

6. The method of claim 1, wherein the first component and the second component are comprised in a component list, and determining the first drawing information of the first component comprises:
determining whether the component list comprises a third component associated with the first component, the third component having a higher priority in the component list than the first component;
in response to the component list not comprising a third component, determining the first start position of the first component based on a predetermined offset of the filling element; and
determining the first end position based on size information of the first component and the first start position.

7. The method of claim 6, wherein determining the first drawing information of the first component comprises:
in response to the component list comprising a third component, determining the first start position of the first component based on third drawing information of the third component; and
determining the first end position of the first component based on the first start location.

8. The method of claim 1, further comprising:
constructing a first node corresponding to the first component and a second node corresponding to the second component;
establishing an association between the first node and the second node to indicate an association between the first component and the second component; and
storing the first drawing information of the first component in the first node.

9. The method of claim 8, wherein determining, based on the first drawing information, the second drawing information of the second component associated with the first component comprises:
in response to completing storage of the first drawing information in the first node, determining the second drawing information based on the first drawing information, to store the second drawing information in the second node.

10. A method of component display, comprising:
filling a first background of a first component and a second background of a second component by using a target element, wherein the first component is adjacent to the second component, and the first component and the second component have different sizes;
displaying the first component and the second component, causing the target element to be continuously presented across the first background of the first component and the second background of the second component; and
in response to a move operation for at least one of the first component or the second component, moving the first component and the second component, causing the first background and the second background to move in coordination with the first component and the second component.

11. The method of claim 10, wherein filling the first background of the first component and the second background of the second component by using the target element comprises:
filling the first background of the first component by using the target element;
determining first drawing information of the first component, the first drawing information comprising at least one of a first start position of the target element or a first end position of the target element in the first component, wherein the first start position and the first end position indicate an offset position of the target element;
determining, based on the first drawing information, second drawing information of a second component associated with the first component, the second drawing information comprising at least one of a second start position of the target element or a second end position of the target element in the second component; and
filling the second background of the second component by using the target element based on the second drawing information.

12. The method of claim 11, wherein determining, based on the first drawing information, the second drawing information of the second component associated with the first component comprises:
determining a target direction of the second component relative to the first component; and
determining the second drawing information of the second component according to the target direction and based on the first drawing information.

13. The method of claim 12, wherein determining the second drawing information of the second component according to the target direction of the second component relative to the first component and based on the first drawing information comprises:
in response to the target direction being a first direction, determining the second end position based on the first start position, or
in response to the target direction being a second direction, determining the second start position based on the first end position.

14. An electronic device, comprising:
at least one processing unit; and
at least one memory coupled to the at least one processing unit and storing instructions for execution by the at least one processing unit, the instructions, when executed by the at least one processing unit, cause the electronic device to perform acts comprising:
filling a first background of a first component by using a target element;
determining first drawing information of the first component, the first drawing information comprising at least one of a first start position of the target element or a first end position of the target element in the first component, wherein the first start position and the first end position indicating an offset position of the target element;
determining, based on the first drawing information, second drawing information of a second component associated with the first component, the second drawing information comprising at least one of a second start position of the target element or a second end position of the target element in the second component; and
filling a second background of the second component by using the target element based on the second drawing information.

15. The electronic device of claim 14, wherein determining, based on the first drawing information, the second drawing information of the second component associated with the first component comprises:
determining a target direction of the second component relative to the first component; and
determining the second drawing information of the second component according to the target direction and based on the first drawing information.

16. The electronic device of claim 15, wherein determining the second drawing information of the second component according to the target direction of the second component relative to the first component and based on the first drawing information comprises:
in response to the target direction being a first direction, determining the second end position based on the first start position, or
in response to the target direction being a second direction, determining the second start position based on the first end position.

17. The electronic device of claim 14, wherein determining the first drawing information of the first component comprises:
determining the first drawing information of the first component based on size information of the first component.

18. The electronic device of claim 17, wherein the size information varies based on content presented in the first component.

19. The electronic device of claim 14, wherein the first component and the second component are comprised in a component list, and determining the first drawing information of the first component comprises:
determining whether the component list comprises a third component associated with the first component, the third component having a higher priority in the component list than the first component;
in response to the component list not comprising a third component, determining the first start position of the first component based on a predetermined offset of the filling element; and
determining the first end position based on size information of the first component and the first start position.

20. The electronic device of claim 19, determining the first drawing information of the first component comprises:
in response to the component list comprising a third component, determining the first start position of the first component based on third drawing information of the third component; and
determining the first end position of the first component based on the first start location.
